(19) United States
(12) Patent Application Publication
(10) Pub. No.: US 2019/0221119 A1
(43) Pub. Date: Jul. 18, 2019

(54) METHOD AND DEVICE FOR PRODUCING A HAZARD MAP FOR IDENTIFYING AT LEAST ONE HAZARDOUS LOCATION FOR A VEHICLE

(71) Applicant: ROBERT BOSCH GMBH, Stuttgart (DE)

(72) Inventor: Volker HOFSAESS, Moeglingen (DE)

(73) Assignee: Robert Bosch GmbH, Stuttgart (DE)

(21) Appl. No.: 16/317,600

(22) PCT Filed: May 15, 2017
(86) PCT No.: PCT/EP2017/061620

§ 371 Date: Jan. 15, 2019

(30) Foreign Application Priority Data
Jul. 15, 2016 (DE) 10 2016 213 015.3

(51) Int. Cl. G08G 1/0967

(52) U.S. Cl. CPC G08G 1/0967

(57) ABSTRACT

The approach introduced here relates to a method for producing a hazard map for identifying at least one hazardous location for a vehicle. In a step of reading in, at least one movement signal is read in, which represents at least one parameter of a movement of the vehicle, and at least one position signal is read in, which represents a geographical position of the vehicle. In a step of outputting, a hazard signal is output for display on or storage in a map using the movement signal and the position signal in order to produce the hazard map when the movement signal has a predefined relationship with a threshold value.

### FIELD OF THE INVENTION

The present approach is based on a device or a method. A computer program is also a subject matter of the present approach.

### BACKGROUND INFORMATION

In developed countries such as Germany, the U.S. or Japan, the traffic safety in road traffic is stagnating. New approaches are needed to achieve the political goal with regard to traffic deaths and also “Vision Zero”, i.e. no personal injuries and/or no traffic accidents. The exploitation of new technologies, the linkage of existing sensors and the utilization of vehicle-related data or environmental data allow for an improvement in the protection of road users or their rescue.

The Japanese document JP 2002149899 A describes a device for predicting hazardous locations on the basis of weather forecasts.

### SUMMARY

Against this background, the approach presented here provides a method and also a device which uses this method, and finally, a corresponding computer program.

A method is provided for producing a hazard map for identifying at least one hazardous location for a vehicle. In a step of reading in, at least one movement signal is read in, which represents at least one parameter of a movement of the vehicle, and at least one position signal is read in, which represents a geographical position of the vehicle. In a step of outputting, a hazard signal is output for display on or storage in a map using the movement signal and the position signal in order to produce the hazard map when the movement signal is in a predefined relationship with a threshold value.

The advantages to be achieved by the introduced approach are that on the basis of at least one movement parameter of a vehicle, at least one hazardous location is able to be detected already prior to an accident. When the hazardous location is displayed on or stored in the hazard map, it may serve as a warning of this hazardous location to other drivers of vehicles.

In the step of reading in, for example, a movement signal in which the parameter of the movement of the vehicle represents a braking movement of the vehicle is able to be read in for this purpose. The threshold value may be specified as braking that corresponds to a reduced acceleration of −2.5 m/s², for instance. The hazard signal may then be output when the vehicle drops below this threshold value, that is to say, when it brakes more forcefully. This makes it possible to use brake values to identify a hazardous location where accidents may loom without an accident necessarily having already occurred there. If a multitude of such hazard signals of a vehicle and possibly also of further vehicles is displayed on the hazard map, then this may provide large-scale information as to where hazardous locations might have to be expected.

According to one specific embodiment, in the step of reading in, at least one further movement may additionally be read in, which represents at least the parameter of the movement of the vehicle or of a further vehicle, and at least one further position signal may be read in which represents the geographical position of the vehicle within a tolerance range. The step of outputting may then be carried out when the movement signal and also the further movement signal have the predefined relationship with the threshold value. The further movement signal and the further position signal may be used to verify the hazardous location prior to outputting the hazard signal, so that only hazard signals that were reliably not triggered by simple inattention on the part of the driver, for instance, are indicated on the hazard map but those that were caused by an actual hazardous location. For better clarity in the hazard map, a hazard signal may then be output in the step of outputting, which is allocated to a position that corresponds to a mean value between the position signal and the further position signal.

According to one specific embodiment, in the step of reading in, at least one item of supplementary information may be read in that represents at least a current state in the environment of the position. For example, an item of supplementary information is able to be read in, in which the state represents at least one item of time information and/or weather information and/or traffic information and/or infrastructure information. The state of the environment may provide information pertaining to the reason for the existence of the hazardous location because the braking behavior may be affected by a time of day/a light condition and/or heavy rain and/or high traffic volume and/or a traffic light system, for instance. The braking behavior is thereby able to be allocated to one of the mentioned factors and also allows for predictions with regard to a corresponding braking behavior in the future.

When the hazard signal is output to at least one device disposed externally from the vehicle in the step of outputting, then a traffic-control center, for example, may be able to view the hazard map, which may then act appropriately. For instance, the traffic-control center may output a change signal, which is developed to change at least one driving parameter of the vehicle using the hazard signal or a further hazard signal. The further hazard signal may be a hazard signal previously output by some other vehicle and read in by the traffic-control center.

The present method may include a step of receiving, in which the described change signal output by the traffic control center or by some other device disposed externally from the vehicle, for example, is received. A driving parameter which is able to be changed in the process could be a velocity of the vehicle, for instance. For reasons of safety, for example, the velocity of the vehicle or of further vehicles may be reduced in the area of the hazardous location.

To ensure that the hazard map is regularly updated, a hazard signal may be output in the step of outputting, which is designed to be displayed on or stored in the map within a predefined time interval. For example, the time interval may correspond to a period of a few minutes and up to several days, weeks, months or years, either in order to be able to display only current hazardous locations or those that may supply information as to where hazardous locations may generally exist. This method is able to be implemented in software or hardware or in a mixed form of software and hardware such as in a control unit.

In addition, the approach introduced here provides a device which is developed to carry out, control or implement the steps of a variant of a method introduced here in corresponding devices. With the aid of this embodiment variant of the approach in the form of a device, as well, the objective on which the present approach is based is able to be achieved in a rapid and efficient manner.

Toward this end, the device may encompass at least one processing unit for processing signals or data; at least one memory unit for storing signals or data; at least one interface with a sensor or an actuator for reading in sensor signals from the sensor or for outputting data or control signals to the actuator; and/or at least one communications interface for reading in or outputting data, which are embedded in a communications protocol. The processing unit may be a signal processor, a microcontroller or the like, for instance, and the memory unit may be a flash memory, an EEPROM, or a magnetic memory unit. The communications interface may be set up to read in or output data in a wireless manner and/or by way of a cable connection, and it is possible that a communications interface which is able to read in or output cable-conducted data is capable of electrically or optically reading in these data from a corresponding data-transmission line, for instance, or capable of outputting the data to a corresponding data-transmission line.

In this instance, a device may be understood as an electrical device which processes sensor signals and outputs control and/or data signals as a function thereof. The device may have an interface which could be developed in hardware and/or software. In the case of a hardware development, the interfaces may be part of what is known as a system ASIC, which encompasses all kinds of functions of the device. However, it is also possible that the interfaces are discrete integrated switching circuits or are at least partially made up of discrete components. In the case of a software development, the interfaces may be software modules which are available on a microcontroller in addition to other software modules, for instance.

In one advantageous embodiment, the device carries out a control of a hazard signal. Toward this end, the device may access sensor signals such as a movement signal and a position signal, for example. The actuation takes place by way of actuators such as a read-in device and an output device.

Also advantageous is a computer-program product or a computer program having program code, which may be stored on a machine-readable carrier or a memory medium such as a semiconductor memory, a hard-disk memory or an optical memory and is used for carrying out, implementing and/or actuating the steps of the present method as recited in one of the previously described specific embodiments, in particular when the program product or the program is executed on a computer or a device.

Exemplary embodiments of the presented approach are shown in the drawing and described in greater detail in the following description.

### BRIEF DESCRIPTION OF THE DRAWINGS

FIG. 1 shows a block circuit diagram of a device for producing a hazard map for identifying at least one hazardous location for a vehicle according to an exemplary embodiment.

FIG. 2 shows a flow diagram of a method for producing a hazard map for identifying at least one hazardous location for a vehicle according to an exemplary embodiment.

FIG. 3 shows a flow diagram of a method for producing a hazard map for identifying at least one hazardous location for a vehicle including measures according to an exemplary embodiment.

FIG. 4 shows a visualization of hazard signals on a hazard map according to an exemplary embodiment.

FIG. 5 shows a visualization of accident data on a map.

FIG. 6 shows a visualization of hazard signals and accident data on a hazard map according to an exemplary embodiment.

FIG. 7 shows a visualization of hazard signals, accident data and supplementary information on a hazard map according to an exemplary embodiment.

FIG. 8 shows a visualization of hazard signals and accident data on a hazard map according to an exemplary embodiment.

FIG. 9 shows a visualization of hazard signals, accident data and supplementary information on a hazard map according to an exemplary embodiment.

FIG. 10 shows a view of supplementary information 700 displayed on a map according to an exemplary embodiment.

### DETAILED DESCRIPTION

In the following description of advantageous exemplary embodiments of the present approach, identical or similar reference numerals are used for the illustrated and similarly acting elements in the various figures, and a repeated description of these elements has been omitted.

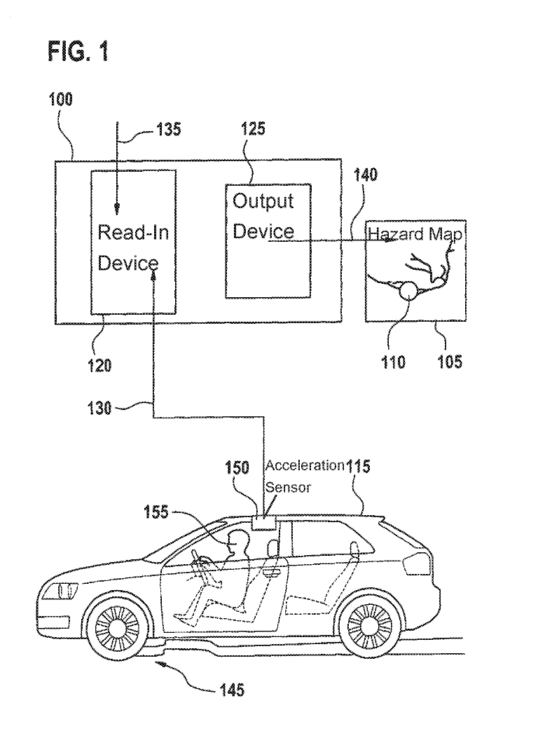

FIG. 1 shows a block circuit diagram of a device 100 for producing a hazard map 105 for the identification of at least one hazardous location 110 for a vehicle 115 according to an exemplary embodiment.

Device 100 has a read-in device 120 and an output device 125. Read-in device 120 is developed to read in at least one movement signal 130, which represents at least one parameter of a movement of vehicle 115, and to read in at least one position signal 135, which represents a geographical position of vehicle 115. Output device 125 is developed to output a hazard signal 140, which is designed to be displayed on and stored in a map using movement signal 130 and position signal 135 in order to produce hazard map 105 when movement signal 130 has a predefined relationship with a threshold value.

According to this exemplary embodiment, read-in device 120 is developed to read in a movement signal 130, in which the parameter of the movement of vehicle 115 represents a braking movement 145 of vehicle 115. According to this particular exemplary embodiment, braking movement 145 is sensed by an acceleration sensor 150 of vehicle 115, which is developed to supply movement signal 130 to read-in device 120. Braking movement 145 is induced by a driver 155 of vehicle 115. According to this exemplary embodiment, hazard signal 140 is output because read-in movement signal 130 drops below a threshold value of −2.5 m/s². According to this exemplary embodiment, hazard signal 140 is displayed on a map, which is located externally from vehicle 115. To do so, the read-in position of vehicle 115 is displayed as hazardous location 110 on hazard map 105.

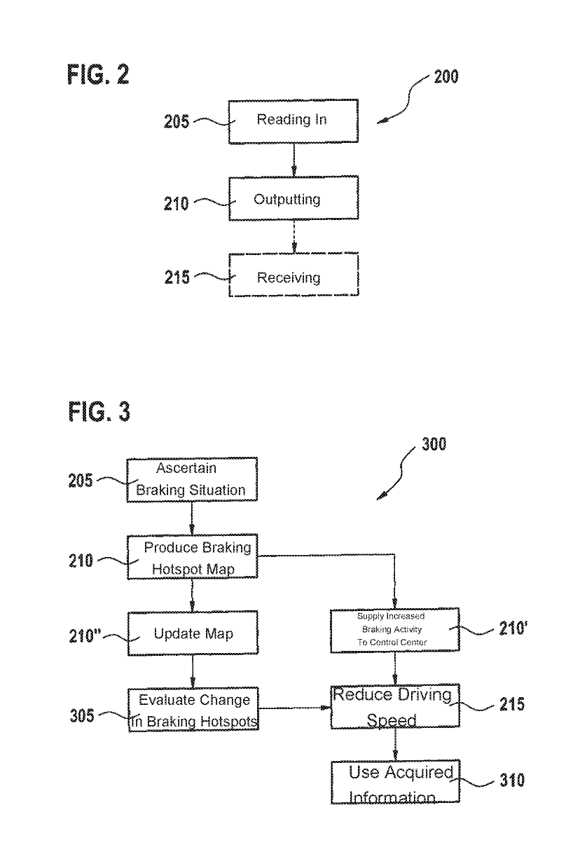

FIG. 2 shows a flow diagram of a method 200 for producing a hazard map in order to identify at least one hazardous location for a vehicle according to an exemplary embodiment. This may be a method 200, which is able to be carried out and/or controlled with the aid of the device introduced in FIG. 1. Method 200 includes at least a step of reading in 205 and a step of outputting 210. Optionally, method 200 according to this exemplary embodiment has a step of receiving 215.

In step 205 of reading in, at least one movement signal, which represents at least one parameter of a movement of the vehicle, is read in, and at least one position signal is read in, which represents a geographical position of the vehicle. In step 210 of outputting, a hazard signal is output, which is developed to be displayed on or stored in a map using the movement signal and the position signal in order to produce the hazard map when the movement signal has a predefined relationship with a threshold value.

In step 215 of receiving, a change signal is received, which is developed to change at least one driving parameter of the vehicle using the hazard signal or a further hazard signal. A change signal, which was output by a device located externally from the vehicle, is able to be received in the process.

According to this exemplary embodiment, in step 205 of reading in, at least one further movement signal which represents at least the parameter of the movement of the vehicle or a further vehicle is read in, and at least one further position signal is read in in addition, which represents the geographical position of the vehicle within a tolerance range; step 210 of outputting is carried out because the movement signal and the further movement signal have the predefined relationship with the threshold value. In step 210 of outputting, a hazard signal is output, which is allocated to a position that corresponds to an averaged value between the position signal and the further position signal.

In addition, in step 205 of reading in, at least one item of supplementary information which represents at least one instantaneous state in the environment of the position is read in. For example, an item of supplementary information is read in, in which the state represents at least one item of time information and/or weather information and/or traffic information and/or infrastructure information. In step 210 of outputting, the hazard signal is output to at least one device which is situated externally from the vehicle; according to this exemplary embodiment, the hazard signal is output to a traffic control center. In addition, in step 210 of outputting, a hazard signal is output, which is displayed on the map or stored within a predefined time interval of, for instance; according to this exemplary embodiment, the hazard signal for a hazard map that is able to be evaluated across a longer period of time, such as 48 hours, is stored in a hazard map.

In the following text, the details of the approach described earlier on the basis of FIG. 2 will be described again in greater detail.

Introduced method 200 may also be referred to as a method for predicting accident hotspots with the aid of vehicle-movement data.

Based on the acquired vehicle-movement data in the form of the movement signals, it is possible to produce a dynamic “braking-hotspot map” in the form of the hazard map. It is known from accident research that a rear-end collision statistically takes place in the course of approximately 10 emergency braking operations, and that an accident involving a pedestrian occurs in approximately 80 emergency-braking operations. Currently, key accident areas or hazardous locations are able to be determined only after accidents have taken place. A criticality classification on the basis of the vehicle-movement data is possible on the basis of the “braking hotspots”. A predictive detection of hazardous locations is used for rerouting recommendations, for instance, or for speed reductions or recommendations for school routes. One special feature of introduced method 200 is that it allows for analyses and statements of very high accuracy, with locations, times, weather, traffic density, etc. At present, experts evaluate key accident areas by monitoring traffic, but without precise databases of the aforementioned factors. In contrast to predictions on the basis of weather forecasts, the present method 200 makes it possible to provide an image of the current situation using actually visualized sensor values.

A detailed description of the approach will follow. To begin with, filtering of the vehicle movement data of vehicles, geo-localization, time stamps, speed, and acceleration takes place, for instance with regard to braking operations of −2.5 m/s² or stronger according to this exemplary embodiment, as described in step 205. Additional analyses are possible that allow for an even more precise statement with the aid of supplementary information such as location and time of day, weather, season, light conditions, traffic volume, intersection types, intersections controlled by traffic lights, e.g., also switching phases or intersections without traffic light systems, business hours of offices/businesses, dependencies on stopping times in the public transportation system, the effect of other road users such as pedestrian crossings, bicycle paths, etc.

Correlations with departure times of subways or suburban trains, for instance, may also be found in the process and visualized on the hazard map.

Possible measures include a reduction of the driving speed either by a traffic control center or directly by speed recommendations via vehicles that are networked with driver-assistance systems, as described in step 215. Additional measures may be a shortening or prolongation of control phases of the traffic-light systems. Direct feedback via instantaneous vehicle-movement data/movement signals is also possible. A change in the measures would thus become immediately obvious. For example, the number of heavy braking operations at a location within several hours may be used as an indicator as to whether the logistics measures lead to an improvement. In addition, emergency services are able to optimize the deployment control through knowledge of “accident-prone” locations. In this context, the stationing of emergency vehicles such as ambulances and/or emergency physicians is based on knowledge of the locations featuring frequent severe braking operations.

FIG. 3 shows a flow diagram 300 for producing a hazard map for identifying at least one hazardous location including measures according to one exemplary embodiment. This may involve method 200 described in FIG. 2 with additional measures.

In step 205, at least one instantaneous braking situation featuring braking operations of more than −2.5 m/s², for example, is ascertained on the basis of vehicle-movement data. In step 210, a “braking hotspot map” is produced and visualized, for instance. According to this exemplary embodiment, in same step 210′, the locations featuring increased braking activity, the magnitude, and number are supplied to a traffic control center or to a provider of vehicle-push services for driver-assistance systems on the one hand, and in step 210″, the “braking hotspot map” is also updated at regular intervals on the other hand. In step 215, measures at the braking hotspots result in a reduction of the driving speed, for instance, such as via the traffic control center.

Steps 305 and 310 show possible measures of the traffic control center, for instance. In step 305, an evaluation of the change in the local braking hotspots with regard to an improvement or a worsening is carried out; step 215 is then able to be executed on the basis of this evaluation. In step 310, acquired information, e.g. that frequent braking takes place at a position due to a kindergarten, is utilized for a construction-site management or for planning school routes.

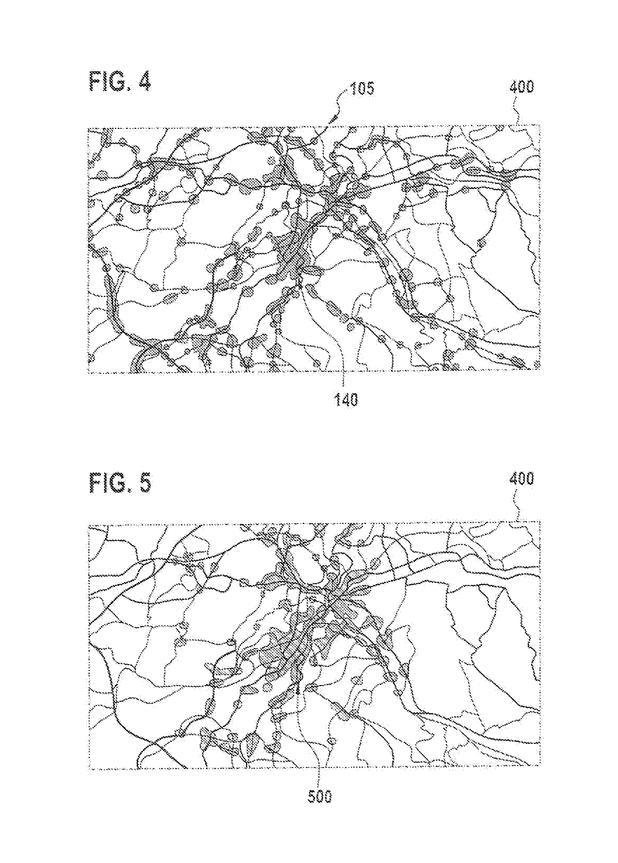

FIG. 4 shows a visualization of hazard signals 140 on a hazard map 105 according to an exemplary embodiment. This may involve hazard map 105 illustrated with the aid of FIG. 1 or one of hazard maps 105 described with the aid of FIG. 2. According to this exemplary embodiment, it is a geographical map 400 of the town of Stuttgart, in which a plurality of hazard signals 140 are exemplarily indicated across a period of two days. Hazard signals 140 may also be referred to as movement data, filtered according to more pronounced braking operations.

FIG. 5 shows a visualization of accident data 500 on a map 400. This is map 400 of the town of Stuttgart described in FIG. 4. A plurality of accident data 500, which represent accidents resulting in personal injuries, is indicated on map 400 over a period of one calendar year. Taking the hazard map in FIG. 4 into account, it is obvious that the hazard signals shown in FIG. 4 and accident data 500 are largely in agreement in this instance.

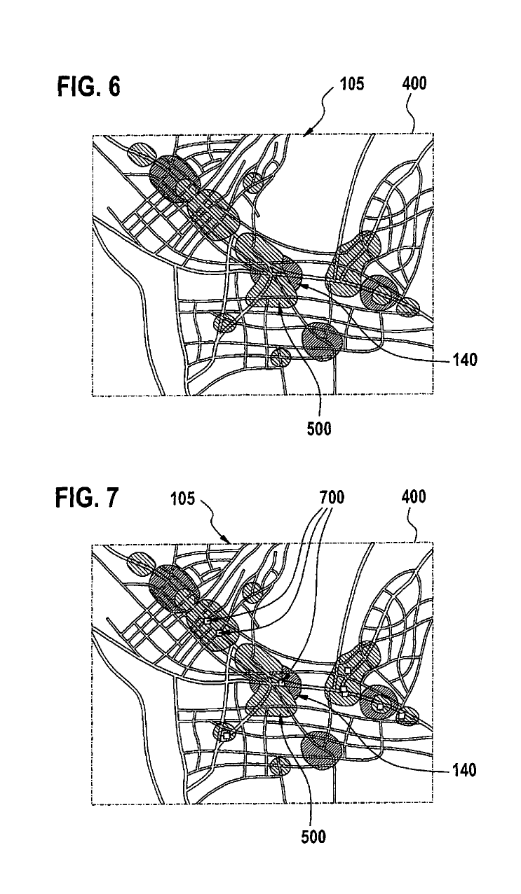

FIG. 6 shows a visualization of hazard signals 140 and accident data 500 on a hazard map 105 according to an exemplary embodiment. Map 400 involves the Stuttgart borough of Sillenbuch, which means that map 400 shows a cutaway of map 400 described in FIGS. 4 and 5. Shown is an identification of correlation points of the two data records in the form of hazard signals 140 and accident data 500 inside narrow district boundaries.

FIG. 7 shows a visualization of hazard signals 140, accident data 500 and supplementary information 700 on a hazard map 105 according to an exemplary embodiment. As in FIG. 6, map 400 relates to the Stuttgart borough of Sillenbuch. Shown is an identification of correlation points of the two data records in the form of hazard signals 140 and accident data 500 inside narrow district boundaries in conjunction with supplementary information 700 in the form of intersections controlled by traffic-light systems.

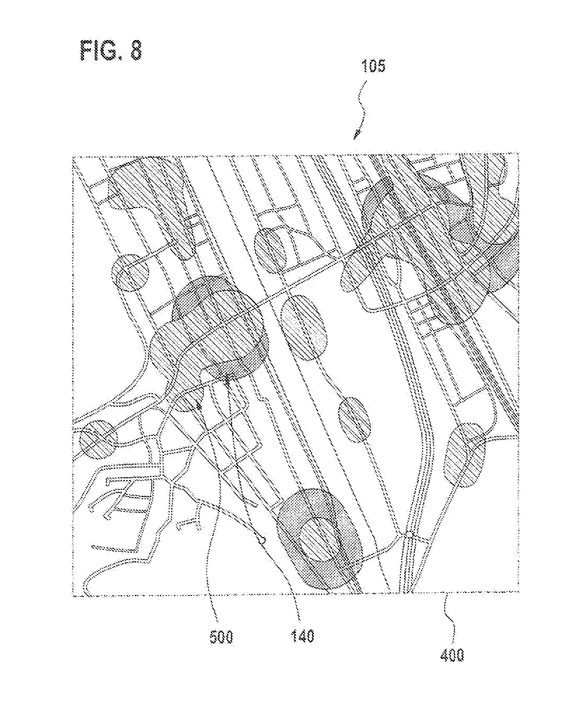

FIG. 8 shows a visualization of hazard signals 140 and accident data 500 on a hazard map 105 according to an exemplary embodiment. Map 400 relates to the Stuttgart borough of Obertürkheim, which means that map 400 shows a further cutaway of map 400 described in FIGS. 4 and 5. Shown is an identification of correlation points of the two data records in the form of hazard signals 140 and accident data 500 inside narrow district boundaries.

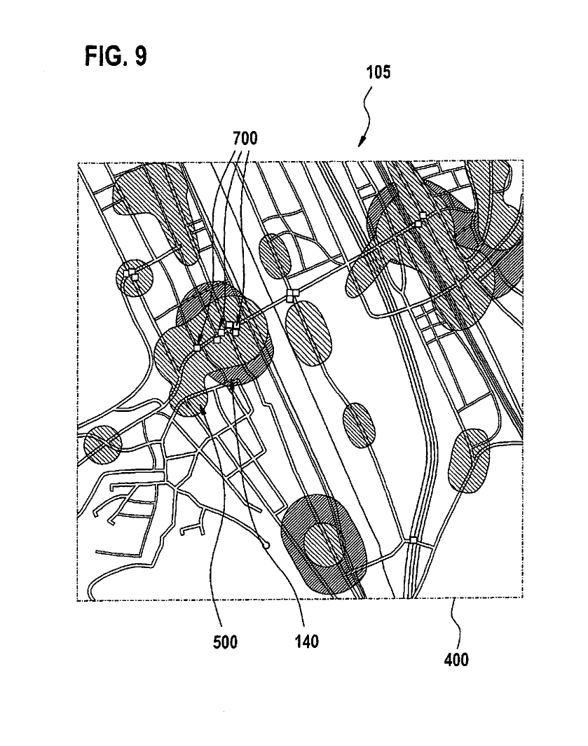

FIG. 9 shows a visualization of hazard signals 140, accident data 500 and supplementary information 700 on a hazard map 105 according to an exemplary embodiment. As in FIG. 8, map 400 relates to the Stuttgart borough of Obertürkheim. Shown is an identification of correlation points of the two data records in the form of hazard signals 140 and accident data 500 inside narrow district boundaries in conjunction with supplementary information 700 in the form of intersections controlled by traffic-light systems.

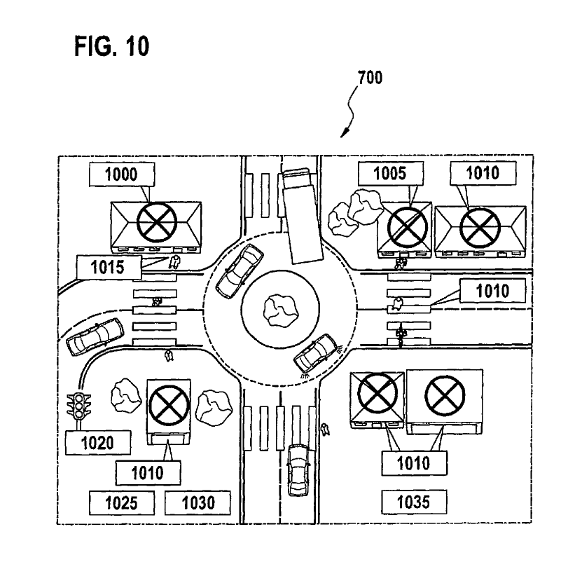

FIG. 10 shows supplementary information 700 according to an exemplary embodiment. This may be supplementary information 700, which is able to be read in by the device described in FIG. 1.

Shown are further data sources in the form of supplementary information 700 for correlations. If one relates the data sources mentioned in the following text and data in the form of hazard signals to one another, further correlations are possible, e.g. at what time a specific intersection is at a particular risk for accidents, such as at night and/or when it is raining and/or on account of a weather-related street condition and/or light conditions and/or a traffic volume, for instance.

Supplementary information 700 shown here represents an opening time of a pharmacy 1000, an opening time of a bank 1005, opening times of further buildings 1010, a kindergarten route 1015, and a control of a traffic-light system 1020. In addition, construction-site information 1025, public transportation departure times 1030, and/or a start and/or a duration of major events 1035 may be part of supplementary information 700. This supplementary information 700, for example, may be able to be read in by a vehicle sensor such as a vehicle camera of the vehicle, or from an interface of the vehicle with a Cloud.

If an exemplary embodiment includes an “and/or” linkage between a first feature and a second feature, then this should be read to mean that the exemplary embodiment according to one embodiment includes both the first feature and the second feature, and according to a further embodiment, includes either only the first feature or only the second feature.

1.-13. (canceled)

14. A method for producing a hazard map for identifying at least one hazardous location for a vehicle, comprising:
reading in at least one movement signal that represents at least one parameter of a movement of the vehicle, and at least one position signal that represents a geographical position of the vehicle; and
outputting a hazard signal for one of display on a map and storage in the map using the movement signal and the position signal in order to produce the hazard map when the movement signal has a predefined relationship with a threshold value.

15. The method as recited in claim 14, further comprising:
reading in at least one further movement signal that represents at least the parameter of the movement of one of the vehicle and a further vehicle;
reading in at least one further position signal that represents the geographical position of the vehicle within a tolerance range, wherein the step of outputting is carried out when the movement signal and the further movement signal have a predefined relationship with the threshold value.

16. The method as recited in claim 15, wherein the step of outputting includes outputting a hazard signal that is allocated to a position that corresponds to an averaged value between the position signal and the further position signal.

17. The method as recited in claim 14, wherein the parameter of the movement of the vehicle represents a braking movement of the vehicle.

18. The method as recited in claim 14, wherein the step of reading includes reading in at least one item of supplementary information that represents at least one current state in an environment of the geographical position.

19. The method as recited in claim 18, wherein the current state represents at least one of an item of time information, an item of weather information, an item of traffic information, and an item of infrastructure information.

20. The method as recited in claim 14, wherein the hazard signal is output to at least one device situated externally from the vehicle.

21. The method as recited in claim 14, wherein the hazard signal is output to be one of displayed on the map and stored in the map within a predefined time interval.

22. The method as recited in claim 14, further comprising:
receiving a change signal for changing at least one driving parameter of the vehicle using one of the hazard signal and a further hazard signal.

23. The method as recited in claim 22, wherein the change signal is output by a device situated externally from the vehicle.

24. A device for producing a hazard map for identifying at least one hazardous location for a vehicle, comprising:
an arrangement for reading in at least one movement signal that represents at least one parameter of a movement of the vehicle, and at least one position signal that represents a geographical position of the vehicle; and
an arrangement for outputting a hazard signal for one of display on a map and storage in the map using the movement signal and the position signal in order to produce the hazard map when the movement signal has a predefined relationship with a threshold value.

25. A computer program for carrying out a method for producing a hazard map for identifying at least one hazardous location for a vehicle, the method comprising:
reading in at least one movement signal that represents at least one parameter of a movement of the vehicle, and at least one position signal that represents a geographical position of the vehicle; and
outputting a hazard signal for one of display on a map and storage in the map using the movement signal and the position signal in order to produce the hazard map when the movement signal has a predefined relationship with a threshold value.

26. A machine-readable memory medium on which is stored a computer program for carrying out a method for producing a hazard map for identifying at least one hazardous location for a vehicle, the method comprising:
reading in at least one movement signal that represents at least one parameter of a movement of the vehicle, and at least one position signal that represents a geographical position of the vehicle; and
outputting a hazard signal for one of display on a map and storage in the map using the movement signal and the position signal in order to produce the hazard map when the movement signal has a predefined relationship with a threshold value.
